(19) United States
(12) Patent Application Publication
(10) Pub. No.: US 2009/0063709 A1
(43) Pub. Date: Mar. 5, 2009

(54) Method for Loading and Maintaining Executable Code Extensions in Instruments

(76) Inventors: Thomas Ambler Rice, Marysville, CA (US); Daniel Lee Pleasant, Santa Rosa, CA (US); David William Grieve, Edinburgh (GB)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/845,390

(22) Filed: Aug. 27, 2007

(51) Int. Cl. G06F 3/00

(52) U.S. Cl. 710/1

(57) ABSTRACT

A synthetic instrument and method for operating the same is disclosed. The synthetic instrument includes a plurality of component modules and a controller. Each component module includes signal processing circuitry that processes input signals thereto to provide output signals that are coupled to a device external to that component module. Each module also includes a memory for storing information specifying the manner in which the input signals are processed to provide the output signals and a network interface that connects the component module to a network within the apparatus. A component download manager within that module loads information into the memory in response to messages received on the network, the component module executing a function that is specified by that information. The controller generates messages on the network specifying data that is to be loaded into at least one of the component modules.

### BACKGROUND OF THE INVENTION

Test instruments were originally compact stand-alone devices that performed physical measurements and displayed the results. For example, an oscilloscope measured the voltage as a function of time at a particular point in a circuit and displayed the result as a simple graph of voltage versus time. As the cost of computational hardware decreased, additional capabilities were incorporated into test instruments to provide increased computational and display capabilities. This new class of instruments typically includes a general-purpose computer that performs various calculations on the raw data and provides more sophisticated data output capabilities including enhanced displays.

A new class of test instruments that are often referred to as “synthetic instruments” have provided additional benefits. A synthetic instrument can be viewed as a system that combines hardware components and software components to generate signals and make measurements that are analogous to the signal generation and measurement functions of a traditional test instrument. A synthetic instrument is constructed from a number of component modules to provide a measurement and display that cannot be carried out by any one of the modules alone. For example, a frequency analyzer can be constructed from a down sampling module that shifts the input signal to an intermediate frequency by mixing the input signal with a local oscillator, a sweep generator that provides the local oscillator frequency, an analog-to-digital converter that measures the amplitude or power of the intermediate frequency signal, and a controller that displays the data and controls the sweep generator. Once programmed, the synthetic instrument operates in a manner that duplicates the functions of a conventional test instrument that makes a predetermined set of measurements in response to a trigger of some form. The various component modules communicate with the controller and each other. This arrangement provides advantages over a conventional test instrument in that the component modules can be utilized in a number of different instruments. In addition, modules from different manufacturers can be more conveniently incorporated in a test instrument from yet another manufacturer.

Many component modules include both hardware and software. The hardware modules are typically constructed from generic hardware such as field-programmable gate arrays (FPGAs), high speed digital signal processors (DSPs), waveform generators, and RF control circuitry. The specific functionality implemented by a module is provided by the software component of the module. While the hardware typically remains fixed over the lifetime of the module, the software can, in principle, be updated to provide additional capabilities or correct errors detected in previous versions of the software. In addition, a module could, in principle, be moved to a different instrument if the software component of the module could be updated to conform to the interface standard of the new instrument. Finally, in some situations, it may be advantageous to alter the software component of an additional module on a temporary basis to perform a particular type of measurement that is not supported in the original version of the module but requires sufficient module resources to make a permanent change in the software unacceptable.

Unfortunately, current modules often do not provide a convenient means for updating the software component of the module. In addition, modules from different manufacturers often utilize different interface standards. Hence, optimum utilization of the high computational capacity of the modules is seldom achieved.

### SUMMARY OF THE INVENTION

The present invention includes a synthetic instrument and method for operating the same. The synthetic instrument includes a plurality of component modules and a controller. Each component module includes signal processing circuitry that processes input signals thereto to provide output signals that are coupled to a device external to that component module. Each module also includes a memory for storing information specifying the manner in which the input signals are processed to provide the output signals and a network interface that connects the component module to a network within the apparatus. A component download manager within that module loads information into the memory in response to messages received on the network, the component module executing a function that is specified by that information. The controller generates messages on the network specifying data that is to be loaded into at least one of the component modules. At least one of the component modules processes an input signal that is received from a device that is external to the apparatus. In one aspect of the invention, one of the component modules includes a FPGA and the information loaded by the component download manager in that module includes a FPGA image. In another aspect of the invention, one of the component modules includes a DSP and the information loaded by the component download manager in that module includes a program to be executed by the DSP. In another aspect of the invention, one of the component download managers returns information specifying a function loaded in the memory of the component module containing that component download manager that can be executed by that component module in response to a message on the network from the controller. In yet another aspect of the invention, upon receiving a message specifying a function to be executed by one the component modules, the component download manager in that module returns a handle that can be used in a subsequent message on the network directed to that component module to cause that component module to execute that function. In another aspect of the invention, upon receiving a message specifying a function to be unloaded by one the component modules, the component download manager in that module removes data needed to execute that function from the memory in that component module. In another aspect of the invention, upon receiving a message requesting a list of the functions that have been previously loaded into the module, the module replies with such a list.

### BRIEF DESCRIPTION OF THE DRAWINGS

FIG. 1 illustrates the hardware components in one embodiment of a synthetic instrument according to the present invention.

FIG. 2 illustrates a component module according to one embodiment of the present invention.

### DETAILED DESCRIPTION OF THE PREFERRED EMBODIMENTS OF THE INVENTION

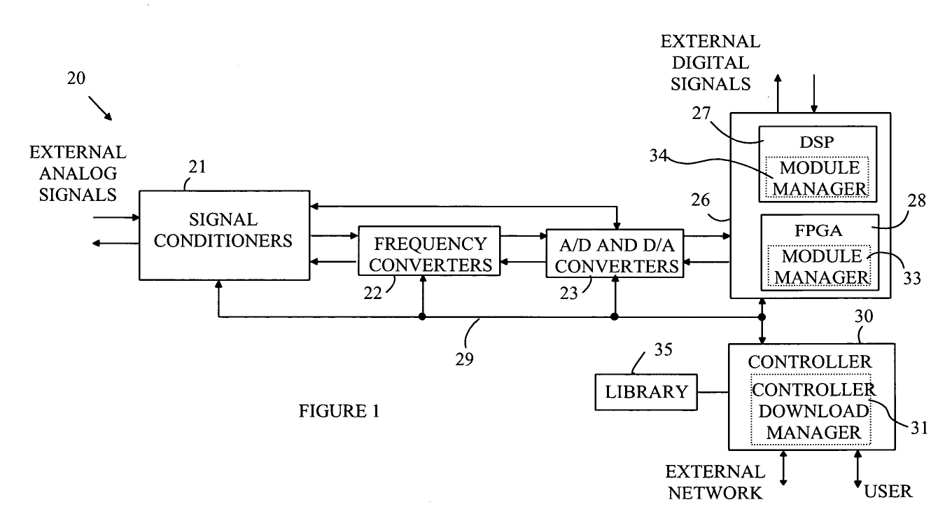

Refer now to FIG. 1, which illustrates the hardware components in one embodiment of a synthetic instrument according to the present invention. Synthetic instrument 20 includes a signal conditioning interface 21 that generates and receives analog signals associated with measurements that are to be made by synthetic instrument 20. Signal conditioning interface 21 includes components such as amplifiers and drivers. In addition, synthetic instrument 20 includes frequency converters 22 that include components such as mixers, RF controllers, DSPs, and FPGAs that are used generate signals in the RF/microwave frequency range and downconvert such signals prior to processing.

Analog signals that are received from the signal conditioners or frequency converters are digitized by a set of analog-to-digital converters in an analog converter module 23. Analog converter module 23 also includes digital-to-analog converters that are used to generate analog signals that sent to the device under test either directly or after further processing by the frequency converters or signal conditioners. It should be noted that analog converter module 23 could also include DSPs and FPGAs that are used to process the data before the data is sent on network 29. Such processing can reduce the bandwidth needed on network 29.

Synthetic instrument 20 can also include special purpose digital processing hardware 26 that generates or converts digital signals that are sent either directly to the device under test or used by one of the other components in Synthetic instrument 20. This hardware may include DSPs and FPGAs as well as high-speed memories used for generating specific signals that are later converted to analog signals.

Controller 30 provides the interface to the user and also controls the various hardware modules via an internal network 29. Controller 30 is typically a general-purpose computer; however, other forms of data processor could be utilized. Controller 30 can also provide some of the high speed digital signal processing provided by the special purpose numeric processors if controller 30 has sufficient computational resources.

Network 29 is preferably a standard Ethernet network; however, other network protocols could be utilized. In one embodiment, TCP/IP protocols are used on network 29. Controller 30 can also provide an interface between the external environment and network 29. The digital data that is transmitted between the processing units and between the processing units and controllers can be transmitted over network 29 or via dedicated connections between the processing units.

A number of the hardware modules described above have downloadable software components that determine the manner in which the modules carry out their functions. To simplify the drawing, these modules have only been explicitly shown in special purpose digital processor 26; however, it is to be understood that any of the modules could have downloadable software components. For example, the special purpose computing hardware 30 includes a DSP 27 that has a code section that can be downloaded into DSP 27 and specifies the specific processing functions performed by DSP 27. In addition, the processing provided by FPGA 28 depends on a software component, referred to as an image, that specifies the connections between the various gates and other components within the array. Similarly, a waveform generator typically includes a memory that stores a digital representation of the various waveforms that can be generated. The stored waveforms could then be processed by a digital signal processor before being converted to analog form.

It should be noted that the specific arrangement shown in FIG. 1 is only one of a number of physical arrangements of the modules. For example, A/D and D/A converters could be present in a signal conditioning interface. Similarly, DSPs and FPGAs could be present in any of the physical components of the instrument. In general, a synthetic instrument can be viewed as a number of components that are connected together by a network and/or additional signal paths. Any of these components could include a module that has a downloadable software component. In addition, a synthetic instrument includes a controller that provides overall organizational control of the components and data flow.

The software component of a module can reside in the module or be split between the module and controller 30. The present invention provides a method for downloading and controlling the software components. By altering the software components, new capabilities can be added to the instrument while the instrument is deployed in the field without requiring that the instrument be returned to the manufacturer. The new capabilities can be temporary or permanent, depending on the specific function being implemented.

A download manager according to the present invention spans the interface between a module and controller 30. Part of the download manager is resident in each module, and part of it is resident in the controller 30. The part of the download manager that is present in FPGA 28 is shown at 33, and the part of the download manager that is present in DSP 27 is shown at 34. The part of the download manager that is present in any given module can be implemented as a general purpose data processor that is added to the conventional processor for that module. Inexpensive data processors with sufficient processing bandwidth to perform the download management functions for a module are readily available and are, in general, more cost effective than utilizing a portion of the hardware in the special purpose processor for the download management function. For example, in the case of a DSP module, a DSP chip could be combined with a general purpose data processor that would manage the download functions for the software in the DSP, and thus, reserve the DSP computational power for high speed computations. Similarly, a general purpose data processor could be combined with a conventional FPGA to form an FPGA module in which the general purpose data processor manages the download functions rather than devoting a large number of gates in the conventional FPGA to the download management function. As will be explained in more detail the portions of the download manager that are contained in the modules communicate with a portion of the download manager 31 that is resident on controller 30. These two portions of the download manager work together transparently to provide a download service for downloading and maintaining software components in the modules.

To simplify FIG. 1, other module download managers have been omitted from the drawing. However, it is to be understood that any module could include a module download manager that provides functions analogous to those described below.

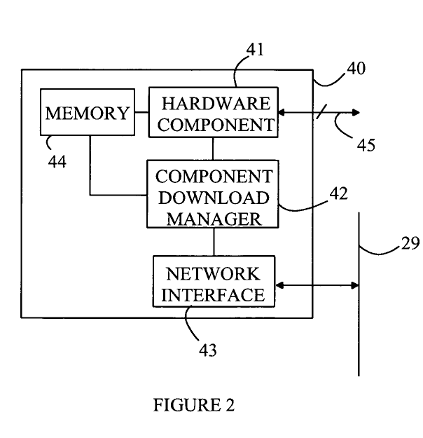

Refer now to FIG. 2, which illustrates the components in a module 40 according to the present invention. Module 40 includes a hardware component 41 that is controlled by a program stored in some form of memory 44. The form of memory 44 will depend on the specific module. Each module that can be the target of a downloadable code operation is connected to network 29 by a network interface 43 and has a separate IP address on that network. The IP addresses can be assigned manually when the modules are connected to the network or automatically by the download manager component in the controller. Alternatively, the IP addresses can be assigned by a controller on network 29 that provides services such as DHCP or AutoIP. The portion of the download manager that is resident in the module will be referred to as the component download manager in the following discussion. Component download manager 42 receives data from network 29 via network interface 43 and performs the functions needed to download information into memory 44 that specifies the behavior of hardware component 41 with respect to signals produced on bus 45 and received therefrom. At power up, firmware within hardware component 41 or component download manager 42 determines which of the devices supervises the power up operations.

The portion of the download manager that is resident in controller 30 will be referred to as the controller download manager 31 in the following discussion. Software that is to be used to provide a payload that is to be stored in memory 44 is input to the controller download manager. The processing provided by the controller download processor for any given module will depend on the nature of that module. The payload may be specified by software that is input to the controller download manager. The software can be in the form of a high level language such as C++. In this case, the controller download manger can pre-process and/or compile the code before the code is downloaded into the modules. The pre-processing allows the internal functionality of the module to be hidden from the user. In one embodiment, only high-level calls are available to the source code. These calls are typically the calls that are available in the module's interface driver on the controller 30. If low-level calls are required, the calls are hidden from the user by utilizing the pre-processing function to expand a high-level function that is made available to the user in the source code into low-level calls that are hidden from the user.

The controller download manager also allows compilers to be installed on controller 30 so that source code can be compiled on controller 30. This allows language extensions such as the custom high-level calls discussed above to be implemented in a manner that is transparent to the user. The controller download manager will make appropriate compiler error messages available to the user during the compilation process.

In one embodiment, the linking of the compiled code is performed at the level of the modules if such linking is required. Scripting languages, or any pseudo-binary code such as Java bytecode or .NET intermediate language binaries, that do not need to be linked are assumed to have the corresponding handlers to be installed in the module. It is generally expected that these handlers will be installed at the factory; however, embodiments in which the handlers are installed at runtime can also be implemented. For instance, a Java bytecode script could be downloaded into a module, followed by Java executables tables.

Some modules include pre-installed executable functions that are provided as part of the module. For some applications, these functions are sufficient to execute the desired function, and hence, the download manager needs only to be able to execute a module query that returns a manifest of the pre-installed functions and the handles corresponding to those functions.

If pre-compiled binary updates or FPGA images are to be downloaded, the download manager simply transfers the code to the target module.

In one embodiment, the download manager implements two data structures or types that are used in communications between controller 30 and one or more of the modules. The Info data structure includes three fields that are returned in response to a query of a module. The first field provides the name of a function. The second field provides an indication of the type of function, i.e., FPGA, C++, etc. The third field is a binary flag that indicates whether or not the function is pre-installed in the module, and hence, cannot be erased. The second data structure is a CodeHandle. This structure is a value of a predetermined number of bytes that can be used to reference executable code that has been loaded into the module.

The controller download manager that is resident on controller 30 implements a number of functions.

Download(Language, Target, Filename)

This routine sends the code stored at Filename to the module identified by Target. In one embodiment, the target module is identified by its IP address on network 29. Language is a string that identifies type of download. If the download requires compilation, the language in which the download code is written is specified in the string. If the download is an FPGA image or previously-compiled binary code, this is also specified in the string. The function returns a CodeHandle that can be used by other programs resident on controller 30 to invoke the downloaded code.

If the downloadable code must be compiled, the download manager must first obtain information about the target module. This is accomplished by utilizing a query function to return data about the module. If the query is carried out when the Download function is invoked, the module must be connected during the query or the download will fail. Alternatively, the query can be performed when the module is connected to network 29 and assigned an IP address. In such an embodiment, a portion of the download manager in controller 30 includes a table that stores the information obtained from such queries.

An executable on a module can be identified by a function name as well as the CodeHandle associated with that function on some modules. The name is specified in the downloadable code and returned as part of the information obtained by the query functions discussed above. Since a function could be loaded by a user that is different from the user responsible for writing a higher level program using the function, the function name provides a convenient method for invoking calls or obtaining the actual handle from the download manager if a consistent naming convention is utilized. To simplify the operation of the download manager, in one embodiment a download that duplicates the name of another function in the module will result in the older function being deleted.

Error messages are provided if the download is unsuccessful. For example, if the downloaded code cannot be executed on the target module, the download function returns an error and does not alter the target module. Similarly, if the code fails to compile either because there is no compiler for the code in the download manager on controller 30, the module is not connected, the code contains errors, or the module has insufficient memory to accept the compiled download, an error message is returned and the module is not altered. These errors are retrieved in one embodiment of the present invention by a function that retrieves the errors. If an error occurs, the download function returns a default value rather than a CodeHandle.

The error messages generated by the last Download call are retrieved by a function, GetLastError( ). The function returns a pointer to the error information in the memory of controller 30. If the most recent Download call was successful, the error information may still include warning messages or other information. If no error information is available, no data is returned. Alternatively, a NULL pointer could be returned.

In one embodiment of the present invention, a downloaded routine remains resident in the module until the routine is unloaded by a separate Unload(Target, ID) function call. Target identifies the module and ID identifies the code that is to be unloaded. In embodiments that utilize the IP addresses to identify the modules, Target is the IP address. ID can be either the function name on the module or the CodeHandle associated with that function.

At any given time, the download manager on controller 30 must be able to determine the executable routines that are currently installed on each module. In principle, the download manager can keep track of the functions as the functions are loaded and unloaded; however, a function on a particular module could be lost due to a power failure or other problem, or through communication with a second controller on the network. In addition, the download manager needs to be able to determine the executables that are available on the module when the module is first installed, i.e., the native executable set associated with the module.

In one embodiment, two query functions are provided to allow the download manager to determine the executables that are available on each module. The first function, QueryFirst(Target, Info) returns the information about the first executable code that is installed in the module and is available for use. This routine also initializes a pointer that allows subsequent calls to QueryNext(Target, Info) to return information about the other executables in order on successive calls. Target is the IP address of the module on network 29 and Info describes the executable. While this embodiment uses a series of calls to elucidate the executables that are available in each module, embodiments in which a list of all of the executables are returned in one call are also possible. The series of calls discussed above reduces the complexity of the download manager, and hence, is preferred in embodiments in which such complexity is an issue.

As noted above, each module must report information specifying the type of module and code set utilized by the module so that the download manager can determine if compilation or pre-processing of a download is needed and, if so, which compiler or preprocessor to use. This information can be provided when the module is installed as part of the installation procedure in a manner similar to plug and play installations used in conventional computer hardware components. However, such an arrangement can be problematic if a module is replaced, the information is lost due to power or other failures, or the module is updated by a means other than the downloadable code mechanism of the present invention. In one embodiment, the QueryFirst function is utilized to provide the base information describing the module and the code set that underlies its operation. The module's first function reports this information rather than a description of an actual executable.

In some embodiments, all of the possible downloadable executables for a particular module may exceed the memory capacity of that module. In a synthetic instrument designed to perform a large variety of measurements, different measurements may utilize different executables at the module level. Since each module has limited memory space, the ability to load and unload data specifying a particular executable function may be needed. To this end, controller 30 can include a library 35 in which information specifying the possible downloads for a particular module can be stored and the current functions implemented on each module. The library can store the specific payloads that are to be transferred to each module to implement a function or function set and/or the source code that is compiled to provide that payload. The library also includes information specifying the download configurations needed for any particular measurement protocol that is implemented on the synthetic instrument. At the beginning of a particular measurement protocol, controller 30 examines the current functions that are programmed into each of the modules to determine if the desired functions are already loaded. If a particular module does not currently have a needed function, controller 30 downloads the information needed to implement the desired function on the module to the module. If necessary, controller 30 unloads one or more of the current functions to free memory in the module. In one embodiment, the QueryFirst function provides information regarding the available memory in a module and the amount of memory that is already utilized. In another embodiment, controller 30 merely unloads functions in response to an error message received when an attempt to download a new function fails for lack of memory.

In the above-described embodiments, the component modules return the code handles or function names assigned to the function in the download command. However, embodiments in which a code handle or function name that is to be used to reference that function in subsequent messages is provided in the download call from the controller can also be constructed.

While the above-described embodiments utilize a controller that is separate from the individual component modules, embodiments in which the controller download manager is implemented in one or more of the component modules can also be implemented. As noted above, one or more of the component modules can be constructed from a conventional special purpose data processing component and a general purpose data processor. One of the general-purpose data processors in question could be processed to provide the controller download manager function as well as the module download manager function for that module.

In the above-described embodiments, network 29 is internal to the instrument and access is protected by the controller download manager or other software on controller 30. Conventional authentication methods can be used to protect the code within the modules from being corrupted by an unauthorized communication on the external network. If network 29 is part of an unsecured network, then the module download managers can implement appropriate authentication and security routines, including encrypted communications, to assure that malicious code is not downloaded or that requests for information are not made from an unauthorized source.

Various modifications to the present invention will become apparent to those skilled in the art from the foregoing description and accompanying drawings. Accordingly, the present invention is to be limited solely by the scope of the following claims.

What is claimed is:

1. An apparatus comprising:
a plurality of component modules, each component module comprising
signal processing circuitry that processes input signals thereto to provide output signals that are coupled to a device external to that component module;
a memory for storing information specifying the manner in which said input signals are processed to provide said output signals;
a network interface that connects said component module to a network within said apparatus;
a component download manager that loads information into said memory in response to messages received on said network, said component module executing a function that is specified by that information;
and a controller that generates messages of said network specifying data that is to be loaded into at least one of said component modules,
wherein at least one of said component modules processes an input signal that is received from a device that is external to said apparatus.

2. The apparatus of claim 1 wherein one of said component modules executes a processing function in response to a trigger signal external to said apparatus.

3. The apparatus of claim 1 wherein one of said component modules comprises a FPGA and said information loaded by said component download manager in that module comprises a FPGA image.

4. The apparatus of claim 1 wherein one of said component modules comprises a DSP and said information loaded by said component download manager in that module comprises a program to be executed by said DSP.

5. The apparatus of claim 1 wherein said external input signal is an analog signal.

6. The apparatus of claim 1 wherein one of said component download managers returns information specifying a function loaded in said memory of said component module containing that component download manager that can be executed by that component module in response to a message on said network from said controller.

7. The apparatus of claim 1 wherein upon receiving a message specifying a function to be executed by one of said component modules, said component download manager in that module returns a handle that can be used in a subsequent message on said network directed to that component module to cause that component module to execute that function.

8. The apparatus of claim 1 wherein upon receiving a message specifying a function to be unloaded by one said component modules, said component download manager in that module removes data needed to execute that function from said memory in that component module.

9. A method for operating a synthetic instrument comprising a plurality of component modules, each component module comprising
signal processing circuitry that processes input signals thereto to provide output signals that are coupled to a device external to that component module;
a memory for storing information specifying the manner in which said input signals are processed to provide said output signals;
a network interface that connects said component module to a network within said apparatus;
a component download manager that loads information into said memory in response to messages received on said network, said component module executing a function that is specified by that information;
and a controller that generates messages of said network specifying data that is to be loaded into at least one of said component modules, said method comprising
generating a message on said network directed to one of said component modules, said message specifying data to be loaded into said memory in one of said component modules, said data specifying a function to performed by that component module; and
receiving a message from that component module indicating that component module has been programmed to execute that function.

10. The method of claim 9 further comprising sending a message on said network to one of said component modules requesting information about functions available on that component module; and receiving a return message from that component module specifying a function stored on that component module.

11. The method of claim 10 wherein said return message specifies whether or not that function can be unloaded from that component module.

12. The method of claim 9 further comprising sending a message on said network to one of said component modules requesting that a function available on that component module be inactivated and memory on that component module related to that function be made available for other functions on that component module.

13. The method of claim 9 wherein one of said component modules comprises a FPGA and said generated message comprises a FPGA image for that component module.

14. The method of claim 9 wherein one of said component modules comprises a DSP and said generated message comprises a program to be executed by said DSP on that component module.
